(19) United States
(12) Patent Application Publication
(10) Pub. No.: US 2026/0271897 A1
(43) Pub. Date: Sep. 17, 2026

(54) FREELY ROTATING DROPSHOT LURE

(71) Applicant: Mitchell Olszewski, Kentwood, MI (US)

(72) Inventor: Mitchell Olszewski, Kentwood, MI (US)

(21) Appl. No.: 19/567,916

(22) Filed: Mar. 16, 2026

Related U.S. Application Data
(60) Provisional application No. 63/772,491, filed on Mar. 15, 2025.

(51) Int. Cl. A01K 85/00; A01K 83/00; A01K 85/01; B33Y 80/00

(52) U.S. Cl. CPC A01K 85/1833; A01K 83/00; A01K 85/015; A01K 85/017; A01K 85/018; A01K 85/1813; A01K 85/1821; A01K 85/1837; A01K 85/1897; B33Y 80/00

(57) ABSTRACT

A fishing lure device including a weight, a weight shaft extending from the weight and terminating in a shaft eye configured for attachment of a fishing line, and a hook having a hook eye that encircles the weight shaft between the weight and the shaft eye, wherein the hook eye is freely rotatable around the weight shaft. The shaft eye may have a diameter larger than an internal diameter of the hook eye such that the shaft eye retains the hook eye on the weight shaft. A bait may be attached to the hook. The bait may be a buoyant elastomeric lure configured to maintain an upward orientation when the weight rests on a bottom substrate. The freely rotatable connection between the hook eye and the weight shaft permits the hook to move independently of the weight in response to water currents.

### CROSS-REFERENCE TO RELATED APPLICATIONS

This application claims priority to U.S. Application No. 63/772,491, filed Mar. 15, 2025, which is hereby incorporated by reference in its entirety.

### BACKGROUND

### 1. Field of the Invention

The present disclosure relates to fishing lures and tackle, and more particularly to a fishing lure device incorporating a freely rotating hook assembly combined with a dropshot weight that enables natural bait movement independent of the weight.

### 2. Description of the Prior Art

Fishing lures have long been used to attract and catch fish in both recreational and commercial fishing applications. These devices come in a wide variety of shapes, sizes, and designs, each intended to mimic the appearance or movement of prey that fish naturally feed on. One popular fishing technique involves the use of dropshot rigs, which typically consist of a weight attached at or near the end of a fishing line with a hook positioned above the weight. This configuration allows bait to be suspended at a specific depth while the weight maintains contact with the bottom substrate of a body of water.

Traditional dropshot rigs and similar weighted fishing assemblies often have the hook fixed in place relative to the weight or fishing line, which can limit the range of motion of the hook and attached bait. This fixed arrangement may reduce the natural appearance of the bait presentation in certain fishing conditions. Additionally, when a fish strikes at a bait that is rigidly connected to a weight, the fish may immediately sense the unnatural resistance or heaviness of the weight, causing the fish to release the bait before an angler can set the hook. This phenomenon can result in missed opportunities and reduced catch rates.

Another challenge with conventional fishing lure designs relates to achieving a natural presentation of the bait in the water. Fish can be wary of artificial lures that do not move in a lifelike manner. Many existing lure designs struggle to accurately mimic the subtle movements and orientations of live prey, particularly when the bait is constrained by a rigid connection to a weight or other terminal tackle component. The weight distribution and hydrodynamics of traditional lures can also affect their action in the water, and some lures may not maintain a desired orientation or may not respond well to water currents or different retrieval techniques.

Furthermore, conventional weighted fishing rigs may be prone to snagging on underwater obstacles, vegetation, or rocky terrain, which can lead to lost tackle and decreased fishing time. There remains a continuing interest in the fishing industry for lure designs that can provide improved bait presentation, enhanced natural movement, and greater versatility across various fishing scenarios and target species.

### SUMMARY

According to an aspect of the present disclosure, a fishing lure device is provided. The fishing lure device includes a weight. The fishing lure device includes a weight shaft extending from the weight and terminating in a shaft eye configured for attachment of a fishing line. The fishing lure device includes a hook having a hook eye that encircles the weight shaft between the weight and the shaft eye, wherein the hook eye is freely rotatable around the weight shaft.

According to other aspects of the present disclosure, the fishing lure device may include one or more of the following features. The weight may be selected from the group consisting of a spherical weight, a cylindrical weight, a teardrop-shaped weight, a disc-shaped weight, and an elongated rod-shaped weight. The fishing lure device may further comprise a bait attached to the hook. The bait may be an elastomeric lure. The elastomeric lure may be shaped to resemble a crayfish. The elastomeric lure may be buoyant such that the bait maintains an upward orientation when the weight rests on a bottom substrate. The hook eye may have an internal diameter larger than an external diameter of the weight shaft such that the hook eye is configured to both rotate around the weight shaft and pivot angularly along an axis of the weight shaft. The shaft eye may have a diameter larger than an internal diameter of the hook eye such that the shaft eye retains the hook eye on the weight shaft. The hook may comprise a barb formed near a hook tip. The weight shaft may be straight along an entire length thereof between the weight and the shaft eye. The weight shaft may be constructed from a corrosion-resistant material.

According to another aspect of the present disclosure, a method of fishing is provided. The method includes providing a fishing lure device comprising a weight, a weight shaft extending from the weight and terminating in a shaft eye, and a hook having a hook eye that encircles the weight shaft between the weight and the shaft eye, wherein the hook eye is freely rotatable around the weight shaft. The method includes attaching a fishing line to the shaft eye. The method includes casting the fishing lure device into a body of water. The method includes allowing the weight to rest on a bottom substrate of the body of water.

According to other aspects of the present disclosure, the method may include one or more of the following features. The method may further comprise attaching a bait to the hook. The bait may be a buoyant elastomeric lure such that the bait maintains an upward orientation relative to the weight when the weight rests on the bottom substrate. The elastomeric lure may be shaped to resemble a crayfish positioned in a defensive posture with claws oriented upwardly. The hook eye may have an internal diameter larger than an external diameter of the weight shaft such that the hook is configured to both rotate around the weight shaft and pivot angularly along an axis of the weight shaft. The method may further comprise setting the hook in a fish that strikes the bait, wherein the fish does not feel resistance from the weight prior to the hook being set due to the freely rotatable connection between the hook eye and the weight shaft.

According to another aspect of the present disclosure, a fishing lure device is provided. The fishing lure device includes a weight configured to rest on a bottom substrate of a body of water. The fishing lure device includes a weight shaft having a first end connected to the weight and a second end opposite the first end, the second end having a shaft eye configured for attachment of a fishing line. The fishing lure device includes a hook comprising a hook eye and a hook tip, the hook eye encircling the weight shaft between the weight and the shaft eye such that the hook is freely rotatable around the weight shaft and freely pivotable along an axis of the weight shaft.

According to other aspects of the present disclosure, the fishing lure device may include one or more of the following features. The fishing lure device may further comprise a buoyant elastomeric bait attached to the hook, wherein the buoyant elastomeric bait is configured to orient the hook at an upward angle relative to the weight shaft when the weight rests on the bottom substrate. The shaft eye may have a diameter larger than an internal diameter of the hook eye such that the shaft eye retains the hook eye on the weight shaft.

For a more complete understanding, reference is made to the following detailed description and accompanying drawings. In the drawings, like reference characters refer to like parts throughout the views in which:

### BRIEF DESCRIPTION OF THE DRAWINGS

FIG. 1 illustrates a perspective view of a dropshot lure, in accordance with an embodiment of the disclosure;

FIG. 2 illustrates a side view of the dropshot lure of FIG. 1 with a bait mounted thereon, in accordance with an embodiment of the disclosure;

FIG. 3 illustrates an enlarged detail view of a connection area between a hook eye and a weight shaft, in accordance with an embodiment of the disclosure;

FIG. 4 illustrates an operational view of the dropshot lure of FIG. 1 at rest on a bottom substrate, in accordance with an embodiment of the disclosure;

FIG. 5 illustrates side views of alternative weight configurations for a dropshot lure, in accordance with an embodiment of the disclosure; and

FIG. 6 illustrates alternative bait configurations for use with a dropshot lure, in accordance with an embodiment of the disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to fishing lures and weights used in fishing. More specifically, the disclosure pertains to a fishing lure device that combines a dropshot weight with a freely rotating hook and bait system. This combination may provide enhanced natural movement of the bait in water while maintaining the benefits of a dropshot weight setup.

In some cases, the fishing lure device includes a weight with a shaft extending from the weight. The shaft may include an eye or loop at a distal end thereof for attaching fishing line. A hook may be mounted on the shaft between the weight and the eye. The hook may include a hook eye that surrounds and rotates around the shaft, allowing the hook to move independently of the weight.

The configuration of the device may allow for the attachment of various types of bait to the hook. When in use, the weight may sink to a bottom of a body of water, while the bait attached to the hook may float or suspend above the bottom. The rotatable nature of the hook on the shaft may allow the bait to move naturally with water currents or fish activity.

This arrangement may offer advantages in certain fishing scenarios, particularly in finesse fishing techniques where natural bait presentation is desired. The device may be suitable for use in various water depths and conditions, depending on the size and shape of the weight used. The freely rotating connection between the hook eye and the weight shaft may enable the bait to respond to subtle water movements, mimicking the behavior of live prey. When a fish strikes the bait, the fish may not immediately feel resistance from the weight due to the rotatable connection, which may result in more committed strikes and improved hookup rates.

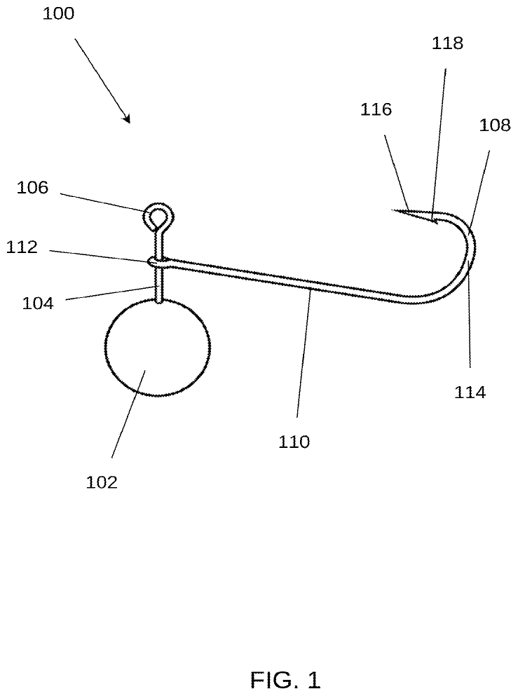

Referring to FIG. 1, a perspective view of a dropshot lure 100 is shown. Dropshot lure 100 includes a weight 102 and a weight shaft 104 extending outwardly from weight 102. Weight shaft 104 terminates in a shaft eye 106 formed at a distal end of weight shaft 104. Shaft eye 106 may be configured for attachment of a fishing line.

A hook 108 is rotatably mounted on the weight shaft 104. The hook 108 includes a hook eye 112 that encircles the weight shaft 104 between the weight 102 and the shaft eye 106. The hook eye 112 may be freely rotatable around the weight shaft 104. This rotatable connection between the hook eye 112 and the weight shaft 104 allows the hook 108 to move independently of the weight 102.

With continued reference to FIG. 1, the hook 108 further includes a hook shaft 110 extending from the hook eye 112. A curved portion 114 extends from the hook shaft 110 and terminates in a hook tip 116. A barb 118 may be formed near the hook tip 116. The barb 118 may assist in retaining a fish once hooked.

The hook 108 may be configured to receive a bait attached thereto. The bait may be skewered onto the hook 108 through the hook shaft 110 and the curved portion 114. The freely rotatable connection between the hook eye 112 and the weight shaft 104 allows the bait to exhibit natural movement in water while the weight 102 maintains position on a bottom surface. When a fish strikes the bait, the fish may not immediately feel resistance from the weight 102 due to the rotatable connection between the hook eye 112 and the weight shaft 104.

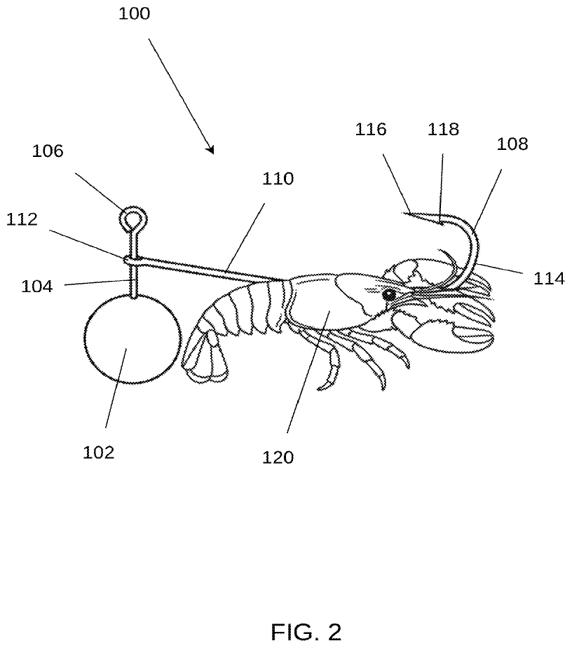

Referring to FIG. 2, the dropshot lure 100 is shown with a bait 120 mounted on the hook 108. The bait 120 may be an elastomeric lure constructed from soft plastic, rubber, silicone, or other flexible polymeric materials. In some cases, the bait 120 may be shaped to resemble a crayfish, as illustrated in FIG. 2. The elastomeric lure shaped to resemble a crayfish may include appendages such as claws, legs, and antennae that move independently in response to water currents.

With continued reference to FIG. 2, the bait 120 is attached to the hook 108 by skewering the bait 120 onto the hook 108. The hook shaft 110 extends from the hook eye 112 horizontally through the bait 120. The curved portion 114 of the hook 108 curves upwardly and forwardly from the hook shaft 110, with the hook tip 116 and the barb 118 protruding from an upper forward portion of the bait 120 near a head region of the crayfish shape. This configuration positions the hook tip 116 and the barb 118 to engage a fish when the fish strikes the bait 120.

As further shown in FIG. 2, the weight 102 is shown as a spherical weight with the weight shaft 104 extending upwardly therefrom. The shaft eye 106 is formed at an upper end of the weight shaft 104. The hook eye 112 encircles the weight shaft 104 between the weight 102 and the shaft eye 106. The rotatable connection between the hook eye 112 and the weight shaft 104 allows the bait 120 to freely rotate and move naturally relative to the weight 102. The hook eye 112 may rotate a full 360 degrees around the weight shaft 104 without mechanical limitation, and the hook eye 112 may also pivot or tilt along the axis of the weight shaft 104. This combined rotational and pivoting freedom enables the bait 120 to mimic the natural, multi-directional movement of live prey in the water.

In some cases, the bait 120 may be configured to float due to the buoyant properties of the elastomeric material from which the bait 120 is constructed. The buoyancy of the bait 120 may cause the bait 120 to maintain an upward orientation when the weight 102 rests on a bottom surface, positioning the bait 120 in a natural defensive posture similar to a live crayfish. The elastomeric lure shaped to resemble a crayfish may include a body portion with segmented tail sections, pincer claws extending forwardly, and multiple leg appendages extending laterally from the body portion.

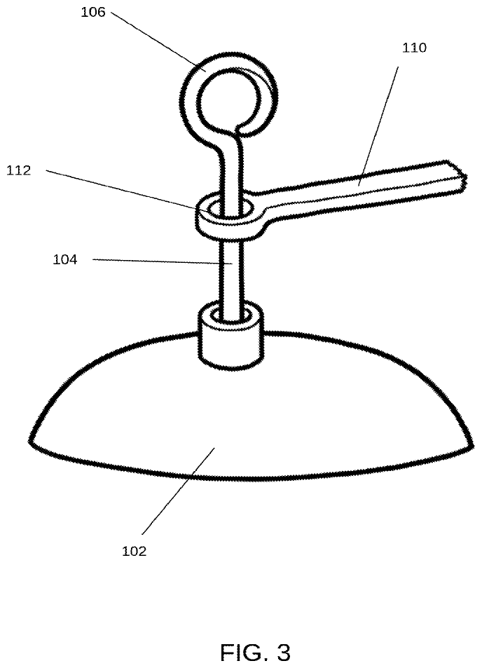

Referring to FIG. 3, an enlarged detail view illustrates a connection area between the hook eye 112 and the weight shaft 104 of a dropshot lure. A weight 102 is shown at a bottom portion of the view, with FIG. 3 depicting a partial view showing only a top portion of the weight 102.

The weight shaft 104 extends upwardly from the weight 102. The hook eye 112 encircles the weight shaft 104 above the weight 102, forming a closed loop around the weight shaft 104 that permits free rotation. A hook shaft 110 extends laterally from the hook eye 112. A shaft eye 106 is formed at an upper end of the weight shaft 104 as an enclosed circular loop.

With continued reference to FIG. 3, the hook eye 112 has an internal diameter larger than an external diameter of the weight shaft 104. This dimensional relationship between the hook eye 112 and the weight shaft 104 enables the hook eye 112 to both rotate around the weight shaft 104 and pivot angularly along an axis of the weight shaft 104. The clearance gap between the hook eye 112 and the weight shaft 104 provides sufficient space for the hook eye 112 to achieve two types of movement relative to the weight shaft 104. A first type of movement includes free rotation around the weight shaft 104, wherein the hook eye 112 may rotate a full 360 degrees around the weight shaft 104 without any mechanical limitation to the rotational range. A second type of movement includes pivoting or angular movement along the axis of the weight shaft 104, allowing a hook attached to the hook eye 112 to tilt upwardly and downwardly rather than being constrained to a single plane of rotation. This combined rotational and pivoting freedom enables an attached bait to mimic natural, multi-directional movement of live prey in water.

As further shown in FIG. 3, the weight shaft 104 is preferably straight along an entire length thereof between the weight 102 and the shaft eye 106. The straight configuration of the weight shaft 104 facilitates free and easy rotation and movement of the hook eye 112 about the weight shaft 104. The shaft eye 106 has a diameter larger than an internal diameter of the hook eye 112 such that the shaft eye 106 retains the hook eye 112 on the weight shaft 104. This retention arrangement prevents the hook eye 112 from sliding off the weight shaft 104 during use while still permitting the hook eye 112 to slide along the weight shaft 104 and rotate freely thereon. The larger diameter of the shaft eye 106 relative to the hook eye 112 acts as a stop that prevents inadvertent disengagement of the hook eye 112 from the weight shaft 104 when a fish strikes or during retrieval of the dropshot lure.

Based upon the foregoing disclosure, it is seen that the present disclosure provides a connection arrangement between the hook eye 112 and the weight shaft 104 that enables unrestricted rotational and pivoting movement of a hook relative to a weight. The dimensional relationship wherein the hook eye 112 has an internal diameter larger than the external diameter of the weight shaft 104 allows bait attached to the hook to respond naturally to water currents and fish activity. The retention feature provided by the shaft eye 106 having a diameter larger than the hook eye 112 maintains the hook on the weight shaft 104 during fishing operations while preserving the free-rotating characteristics of the connection.

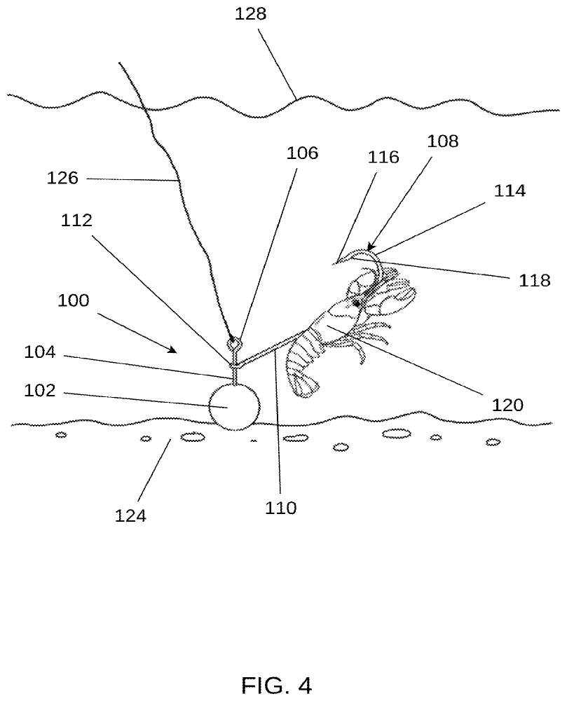

Referring to FIG. 4, the dropshot lure 100 is shown in an operational configuration at rest on a bottom substrate 124 of a body of water. A fishing line 126 extends from above a water surface 128, angling downward through the water column to connect to the shaft eye 106 at the second end of the weight shaft 104. The shaft eye 106 is configured for attachment of the fishing line 126, providing a connection point that allows an angler to control the position of the dropshot lure 100 within the body of water.

As shown in FIG. 4, the weight 102 is configured to rest on the bottom substrate 124 of the body of water. The weight 102, shown as a spherical sinker in FIG. 4, maintains contact with the bottom substrate 124 and anchors the dropshot lure 100 in position. The weight shaft 104 extends upwardly from the weight 102, with a first end connected to the weight 102 and a second end opposite the first end where the shaft eye 106 is formed.

With continued reference to FIG. 4, the hook eye 112 encircles the weight shaft 104 between the weight 102 and the shaft eye 106 such that the hook 108 is freely rotatable around the weight shaft 104 and freely pivotable along an axis of the weight shaft 104. The bait 120, which may be a buoyant elastomeric bait, is attached to the hook 108. The buoyant elastomeric bait is configured to orient the hook 108 at an upward angle relative to the weight shaft 104 when the weight 102 rests on the bottom substrate 124. As depicted in FIG. 4, the hook shaft 110 extends from the hook eye 112 upwardly and to the right at an angle of approximately 35-40 degrees relative to the weight shaft 104.

The buoyancy of the bait 120 exerts an upward force on the hook 108, causing the hook 108 to angle upward while the hook eye 112 remains positioned on the weight shaft 104 near the bottom substrate 124. In some cases, the buoyant elastomeric bait is shaped to resemble a crayfish positioned in a defensive posture. As shown in FIG. 4, the bait 120 is an elastomeric crayfish-shaped lure with claws oriented upwardly in a defensive posture. The elastomeric lure may be buoyant such that the bait 120 maintains an upward orientation when the weight 102 rests on the bottom substrate 124. This upward-angled orientation simulates the natural posture of prey such as a crayfish resting on the bottom of a lake bed with a front portion angled upward in a defensive posture, which may increase attractiveness to fish.

Based upon the foregoing disclosure, it is seen that the present disclosure provides a fishing lure device that allows the bait 120 to exhibit natural movement and orientation in the water while the weight 102 remains stationary on the bottom substrate 124. The freely rotatable and freely pivotable connection between the hook eye 112 and the weight shaft 104 enables the bait 120 to respond to water currents and orient naturally due to buoyancy forces, presenting a lifelike appearance to fish. The configuration where the fishing line 126 attaches to the shaft eye 106 rather than directly to the hook 108 may reduce the likelihood of fish detecting resistance when striking the bait 120, as the rotatable connection isolates the hook 108 from the mass of the weight 102 during the initial strike.

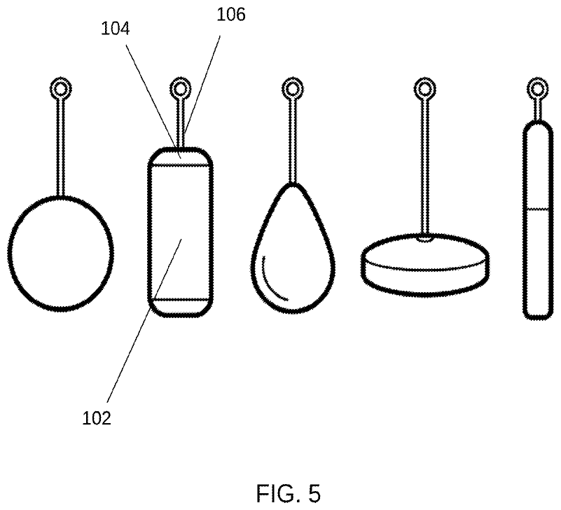

Referring to FIG. 5, five alternative configurations for the weight 102 are illustrated. Each configuration includes the weight 102 with the weight shaft 104 extending upwardly therefrom and the shaft eye 106 formed at an upper end of the weight shaft 104. The five configurations demonstrate the versatility of weight shapes that may be used with the dropshot lure while maintaining the same structural arrangement of the weight 102, the weight shaft 104, and the shaft eye 106.

A first weight 102, shown at the left of FIG. 5, is spherical. The spherical configuration corresponds to the primary embodiment shown in FIGS. 1-4 and described previously. The spherical shape may provide consistent rolling characteristics when the dropshot lure contacts the bottom substrate during retrieval.

With continued reference to FIG. 5, a second weight 102 is cylindrical. The cylindrical configuration has a height greater than a diameter thereof with rounded upper corners. The cylindrical shape may provide a different profile and sinking characteristic compared to the spherical configuration.

A third weight 102 is teardrop-shaped. The teardrop-shaped configuration has a wider rounded bottom end tapering toward a narrower top end where the weight shaft 104 connects. The tapered end of the teardrop-shaped weight 102 may reduce snagging in rocky terrain by allowing the weight 102 to slide over and around obstacles more readily than other configurations.

A fourth weight 102 is disc-shaped. The disc-shaped configuration has a low profile with a diameter much greater than a thickness thereof. The disc-shaped or coin-shaped weight 102 may provide a lower profile on the bottom substrate, which may be advantageous in certain fishing conditions where a reduced vertical presence is desired.

A fifth weight 102, shown at the right of FIG. 5, is elongated and rod-shaped. The elongated rod-shaped configuration has a length much greater than a width thereof. In some cases, the elongated rod-shaped weight 102 may be pencil-shaped with a tapered end to further reduce snagging in rocky terrain.

In some cases, the weight 102 may incorporate a flattened bottom surface to provide stability on soft substrates such as mud or silt. The weight 102 may feature an irregular or textured outer surface to mimic natural bottom debris, which may enhance the natural appearance of the dropshot lure when resting on the bottom substrate. In some cases, the weight 102 may be configured with fins or stabilizing protrusions to control orientation during descent through the water column. The weight 102 may also be banana-shaped or curved to provide a rocking motion when disturbed by water currents, which may attract fish by creating additional movement near the bottom substrate.

Based upon the foregoing disclosure, it is seen that the present disclosure provides a dropshot lure with multiple alternative weight configurations that allow anglers to select a weight shape suited to particular fishing conditions. The spherical, cylindrical, teardrop-shaped, disc-shaped, and elongated rod-shaped configurations each offer different performance characteristics while maintaining the freely rotating hook assembly that enables natural bait movement. The variety of weight shapes addresses different bottom substrate conditions, snagging concerns, and presentation preferences, thereby enhancing the versatility and effectiveness of the dropshot lure across diverse fishing environments.

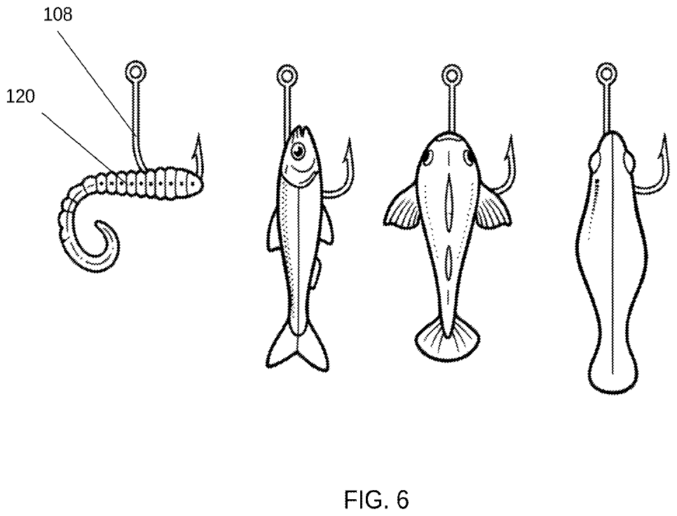

Referring to FIG. 6, four alternative bait 120 configurations are shown for use with the hook 108 of the dropshot lure 100. Each bait 120 configuration demonstrates the versatility of the dropshot lure 100 to accommodate various bait shapes beyond the crayfish form shown in FIGS. 2 and 4.

A first bait 120 shown in FIG. 6 is a grub worm having a segmented cylindrical body with a curled tail. The curled tail may provide additional action in the water as water currents cause the tail to undulate and move. The hook 108 extends through the grub worm body to secure the bait 120 thereon.

A second bait 120 shown in FIG. 6 is a minnow having a streamlined body with a lateral line, fins, and a forked tail fin. The minnow shape may mimic regional forage species that predatory fish naturally feed upon.

With continued reference to FIG. 6, a third bait 120 is shown as a goby or catfish in a front belly view. The goby or catfish has a wide flat head, whiskers, broad pectoral fins, and a fan-shaped tail fin. The broad pectoral fins and tail fin may move independently with water currents to create lifelike action.

A fourth bait 120 shown in FIG. 6 is a leech having an elongated, segmented body with a tapered profile. The leech shape may mimic natural leeches that are common forage for bottom-dwelling predatory fish in many freshwater environments.

In some cases, the bait 120 may incorporate appendages such as paddle tails, ribbon tails, curly tails, or split tails to provide additional action in the water. The bait 120 may also feature multiple appendages including legs, claws, antennae, or fins that move independently with water currents. The rotatable connection between the hook eye 112 and the weight shaft 104 allows each bait 120 configuration to freely rotate and orient naturally in response to water currents while the weight 102 remains stationary on the bottom substrate.

The weight 102 may be constructed from various materials depending on performance requirements, cost considerations, and environmental regulations. In some cases, the weight 102 may be fabricated from lead, which provides high density and ease of manufacturing. In other cases, the weight 102 may be constructed from tungsten, which offers greater density than lead in a more compact form factor. The weight 102 may also be made from brass, which provides corrosion resistance and moderate density.

For environmental compliance in regions where lead is restricted, the weight 102 may be constructed from zinc alloys, steel, bismuth, or tin-based alloys. Zinc alloys provide adequate density while meeting environmental regulations in freshwater fishing areas. Steel weights offer durability and corrosion resistance when properly coated. Bismuth provides density characteristics similar to lead without the associated environmental concerns. Tin-based alloys may be formulated to achieve desired weight characteristics while maintaining compliance with lead-free requirements.

In some cases, the weight 102 may incorporate composite materials combining a dense metal core with an outer polymer coating for enhanced sensitivity applications. The dense metal core provides the mass needed for bottom contact and casting distance, while the polymer coating may reduce noise when the weight 102 contacts rocks or other hard substrates. The polymer coating may also provide a softer feel that transmits subtle bottom composition changes to the angler through the fishing line 126.

The weight 102 may be constructed from recycled metals or eco-friendly materials such as iron-concrete composites or ceramic-metal hybrids. Iron-concrete composites combine iron particles with a concrete binder to achieve adequate density for sinking performance while using readily available and environmentally benign materials. Ceramic-metal hybrids may incorporate ceramic particles within a metal matrix to achieve desired density and durability characteristics.

The weight 102 component may range from approximately ⅛ ounce to ¾ ounce for freshwater applications. Lighter weights of approximately ⅛ ounce to 3/16 ounce may be used in shallow water or calm conditions where a subtle presentation is desired. A weight 102 of approximately ¼ ounce represents a common size that provides a balance between sensitivity and bottom contact maintenance across a variety of conditions. Heavier weights of approximately ⅜ ounce to ½ ounce may be employed in deeper water or moderate current conditions. Weights of approximately ¾ ounce may be used in strong current situations or very deep water where additional mass is needed to maintain bottom contact.

The weight shaft 104 may be configured in various lengths depending on the desired separation between the weight 102 and the hook 108. In some cases, the weight shaft 104 may range from approximately 0.5 inches to 3 inches in length. Shorter weight shaft 104 lengths may be selected for shallow water fishing applications or when minimal separation between the weight 102 and the bait 120 is desired. Longer weight shaft 104 lengths may be selected for deeper water applications or when greater separation between the weight 102 and the bait 120 is desired to achieve a particular bait presentation.

The weight shaft 104 is preferably straight along its entire length to facilitate free and easy rotation and movement of the hook 108 and the hook eye 112 about the weight shaft 104. A straight configuration reduces binding or interference that could otherwise restrict the rotational freedom of the hook eye 112. The weight shaft 104 also has a preferably circular cross-section to facilitate free and easy rotation and movement of the hook 108 and the hook eye 112. A circular cross-section provides a uniform bearing surface around which the hook eye 112 may rotate without encountering edges or flat surfaces that could impede rotation.

In some cases, the weight shaft 104 may be constructed with varying diameters along its length. The weight shaft 104 may feature a thicker section near the weight 102 for structural integrity and a thinner section where the hook eye 112 rotates to reduce friction. The thicker section near the weight 102 provides increased strength at the connection point between the weight shaft 104 and the weight 102 body, while the thinner section at the hook eye 112 location reduces the contact area between the hook eye 112 and the weight shaft 104, thereby reducing frictional resistance to rotation.

The weight shaft 104 may incorporate a smooth polished surface finish to facilitate free rotation of the hook eye 112. A polished surface reduces surface roughness and minimizes friction between the hook eye 112 and the weight shaft 104 during rotation. In some cases, the weight shaft 104 may be coated with low-friction materials to enhance hook 108 rotation. Low-friction coatings such as polytetrafluoroethylene (PTFE) or ceramic coatings may be applied to the weight shaft 104 surface to further reduce rotational resistance.

The weight shaft 104 may be constructed from a corrosion-resistant material to resist degradation in freshwater or saltwater environments. In some cases, the weight shaft 104 may be constructed from stainless steel. In other cases, the weight shaft 104 may be constructed from titanium. The weight shaft 104 may also be constructed from nickel alloys or coated carbon steel. The selection of corrosion-resistant materials extends the service life of the fishing lure device 100 and maintains smooth rotational characteristics of the hook eye 112 over repeated use in aquatic environments.

In some cases, the weight shaft 104 may feature a slight bend or offset angle to position the hook 108 at a predetermined orientation relative to the weight 102. An angled shaft configuration may be selected when a particular hook 108 orientation is desired for a specific fishing technique or bait 120 presentation. However, a straight shaft configuration is generally preferred to maximize rotational freedom of the hook eye 112.

The hook eye 112 may be configured in various shapes to provide different ranges of motion around the weight shaft 104. In some cases, the hook eye 112 may be circular in shape, providing uniform rotational freedom in all directions around the weight shaft 104. In other cases, the hook eye 112 may be oval in shape, which may provide a different range of motion characteristics compared to a circular configuration. The hook eye 112 may also be elongated, which may permit the hook 108 to move through a wider arc relative to the weight shaft 104 during use.

The hook eye 112 may have an internal diameter larger than an external diameter of the weight shaft 104. This dimensional relationship between the hook eye 112 internal diameter and the weight shaft 104 external diameter may allow the hook 108 to both rotate around the weight shaft 104 and pivot angularly along an axis of the weight shaft 104. The rotational movement permits the hook 108 to spin freely around the weight shaft 104 in a plane perpendicular to the shaft axis. The angular pivoting movement permits the hook 108 to tilt upward and downward relative to the weight shaft 104 rather than being constrained to a single plane of rotation. This combined rotational and pivoting freedom may enable an attached bait 120 to mimic natural, multi-directional movement of live prey in water.

The hook eye 112 may incorporate a bearing surface to enhance rotational freedom on the weight shaft 104. In some cases, the hook eye 112 may include a low-friction coating to reduce resistance during rotation. The low-friction coating may be PTFE (polytetrafluoroethylene). In other cases, the low-friction coating may be ceramic. These coatings may reduce friction between the hook eye 112 and the weight shaft 104, permitting smoother and more responsive movement of the hook 108 in response to water currents or fish activity.

The hook eye 112 may be constructed with a reinforced cross-section to withstand forces encountered when fighting large fish. In some cases, the hook eye 112 may have a thickened cross-section compared to other portions of the hook 108 wire. This reinforcement may provide additional strength at the connection point between the hook 108 and the weight shaft 104, where stress concentrations may occur during hook setting and fish fighting.

Hook 108 sizes for use with the dropshot lure 100 may range from #6 to 2/0 for freshwater applications. In some cases, hook 108 sizes ranging from #4 to 1/0 may be used. In other cases, hook 108 sizes of #2 to #1 may be used for freshwater drop shot applications. The selection of hook 108 size may depend on factors such as target fish species, bait 120 size, and fishing conditions. Smaller hooks such as #6 or #4 may be used for panfish or finesse presentations, while larger hooks such as 1/0 or 2/0 may be used when targeting larger bass or other predatory fish species.

The hook 108 may be provided in various styles depending on the target species and fishing technique employed by an angler. In some cases, the hook 108 may be an offset hook having a bend in the shank that positions the hook point laterally offset from the shank axis. In other cases, the hook 108 may be a wide-gap hook having an enlarged distance between the hook shank 110 and the hook point to accommodate bulkier baits or to improve hookup rates with fish that have larger mouths. The hook 108 may be a circle hook having a curved point that turns inward toward the shank, which may reduce deep hooking and facilitate catch-and-release fishing. In some implementations, the hook 108 may be an octopus hook having a short shank and a wide gap with a turned-up eye, which may be suitable for live bait presentations. The hook 108 may also be a finesse hook having a lighter wire gauge and smaller profile for subtle presentations targeting wary fish.

The hook 108 may incorporate a weedless configuration to reduce snagging in vegetated areas or around submerged structure. In some cases, a wire guard may extend from the hook eye 112 toward the hook tip 116, shielding the hook point from contact with vegetation, rocks, or other debris. The wire guard may be a single wire or multiple wires arranged to deflect obstacles away from the hook point while still permitting fish to compress the guard and expose the hook point during a strike.

The hook 108 may feature various shank configurations. In some cases, the hook 108 may have a straight shank extending linearly from the hook eye 112 to the curved portion 114. In other cases, the hook 108 may have a bent shank incorporating one or more bends along the shank length, which may position the bait 120 at a particular angle or orientation relative to the hook eye 112. The hook 108 may have an extra-wide gap configuration in which the distance between the shank and the hook point is enlarged beyond standard dimensions, which may improve bait 120 presentation and hookup efficiency with certain bait styles.

The hook 108 may be provided with different point styles. In some cases, the hook 108 may have a needle point that tapers to a fine, rounded tip for smooth penetration. In other cases, the hook 108 may have a knife edge point having flattened sides that converge to a sharp edge, which may provide enhanced cutting action during hook sets. The hook 108 may have a rolled point in which the tip curves slightly inward toward the shank, which may improve hook retention once the hook 108 penetrates fish tissue.

The hook 108 may incorporate various barb 118 configurations. In some cases, the hook 108 may include multiple barbs positioned along the hook bend or near the hook tip 116 to improve fish retention. In other cases, the hook 108 may be a barbless design having no barb formed on the hook 108, which may facilitate easier hook removal and reduce injury to fish in catch-and-release applications. Barbless hooks may also be required by fishing regulations in certain jurisdictions or water bodies.

The hook 108 may be coated with corrosion-resistant finishes to extend service life in freshwater or saltwater environments. In some cases, the hook 108 may have a black nickel coating that provides corrosion resistance and a low-visibility appearance in the water. In other cases, the hook 108 may have a red finish that may serve as a visual attractant by mimicking the appearance of blood or injured prey. The hook 108 may be coated with fluoropolymer coatings that reduce friction during hook penetration and provide enhanced corrosion protection. Other coating options may include bronze, tin, or cadmium finishes depending on the intended fishing application and environmental conditions.

The bait 120 may be attached to the hook 108 through various methods depending on the fishing technique and target species. In some cases, the bait 120 may be nose-hooked, wherein the hook 108 penetrates through a forward or nose region of the bait 120. In some cases, the bait 120 may be wacky-rigged, wherein the hook 108 penetrates through a middle region of the bait 120 perpendicular to a longitudinal axis of the bait 120. In some cases, the bait 120 may be Texas-rigged, wherein the hook point is embedded within the body of the bait 120 such that the hook point does not protrude from an outer surface of the bait 120, thereby reducing snagging on underwater structures and vegetation.

The bait 120 may be secured to the hook 108 using a bait keeper barb or collar positioned on a shaft of the hook 108. The bait keeper barb or collar may comprise a raised projection or series of projections extending outwardly from the hook shaft 110 that engage the bait 120 material and resist sliding movement of the bait 120 along the hook shaft 110. In some cases, the bait 120 may be attached using an external bait holder clip or spring mechanism. The external bait holder clip or spring mechanism may be configured to grip the bait 120 and maintain the bait 120 in a fixed position relative to the hook 108 without requiring the hook 108 to penetrate through the bait 120 material.

In some cases, the bait 120 may incorporate a pre-formed channel or cavity designed to receive the hook shaft 110 for consistent rigging. The pre-formed channel or cavity may extend longitudinally through a portion of the bait 120 body and may be sized to correspond to a diameter of the hook shaft 110. The pre-formed channel or cavity may facilitate repeatable positioning of the hook 108 within the bait 120 and may reduce damage to the bait 120 material during rigging.

The bait 120 may be constructed from various elastomeric materials. In some cases, the bait 120 may be constructed from thermoplastic elastomers (TPE). In some cases, the bait 120 may be constructed from polyvinyl chloride (PVC) plastisols. In some cases, the bait 120 may be constructed from silicone rubber. In some cases, the bait 120 may be constructed from biodegradable polymers. The selection of bait 120 material may depend on factors such as desired flexibility, durability, buoyancy characteristics, and environmental considerations.

The bait 120 may incorporate varying degrees of buoyancy to achieve different presentations in the water. In some cases, the bait 120 may include air pockets distributed throughout an elastomeric body of the bait 120 to provide positive buoyancy. In other cases, the bait 120 may include foam inserts positioned within the elastomeric body to reduce overall density and increase buoyancy. The bait 120 may also incorporate low-density fillers such as hollow glass microspheres dispersed throughout the elastomeric material to achieve a desired buoyancy level while maintaining structural integrity of the bait 120.

In some cases, the bait 120 may be formulated with neutral buoyancy to suspend horizontally in the water column. A neutrally buoyant bait 120 may remain at a substantially constant depth when the dropshot lure 100 is at rest, neither rising toward the water surface 128 nor sinking toward the bottom substrate 124. Neutral buoyancy formulations may be achieved by balancing the density of the elastomeric material with the inclusion of appropriate amounts of low-density fillers or air pockets.

The bait 120 may incorporate weighted inserts to achieve specific orientations in the water. In some cases, the bait 120 may include lead beads positioned within a head region of the bait 120 to achieve a head-down orientation. In other cases, the bait 120 may include tungsten beads positioned within a tail region of the bait 120 to achieve a tail-down orientation. The weighted inserts may be encapsulated within the elastomeric material during molding or may be inserted into pre-formed cavities within the bait 120.

In some cases, the bait 120 may be constructed with a density gradient to achieve specific orientations in the water. The bait 120 may feature a buoyant tail section having a lower density than a head section of the bait 120. The denser head section may cause the bait 120 to orient with the head angled downward while the buoyant tail section rises upward. Such density gradient construction may be achieved by molding the bait 120 from two or more elastomeric materials having different densities, or by selectively positioning weighted inserts or low-density fillers within specific regions of the bait 120.

The bait 120 may include appendages that provide additional action in the water. In some cases, the bait 120 may include a paddle tail that oscillates or wobbles when the bait 120 moves through the water. In other cases, the bait 120 may include a ribbon tail, a curly tail, or a split tail that undulates in response to water currents or angler-imparted movement. The bait 120 may also include multiple appendages such as legs, claws, antennae, or fins that move independently with water currents. The independent movement of multiple appendages may enhance the lifelike appearance of the bait 120 and increase attractiveness to fish. The appendages may be formed integrally with the elastomeric body of the bait 120 or may be attached as separate components.

The weight 102 may incorporate various visual elements to enhance fish attraction. In some cases, the weight 102 may include painted eyes positioned on an outer surface of the weight 102 to simulate the appearance of a prey item. The weight 102 may also incorporate scale patterns applied to the outer surface to mimic the texture and appearance of fish scales. Other visual elements such as gill markings, lateral lines, or fin patterns may be applied to the weight 102 to further enhance the lifelike appearance.

In some cases, the weight 102 may be coated with reflective finishes to create flash in the water. The reflective finish may comprise a metallic coating such as chrome, silver, or gold that reflects ambient light as the weight 102 moves through the water column. The weight 102 may alternatively be coated with holographic finishes that produce multi-colored light reflections when illuminated. The holographic coating may create prismatic effects that simulate the flash produced by baitfish scales, thereby attracting predatory fish from a distance.

The bait 120 may incorporate UV-reactive pigments for low-light fishing conditions. UV-reactive pigments absorb ultraviolet light and emit visible light, making the bait 120 more visible to fish in deep water, murky conditions, or during dawn and dusk periods when UV light penetration is elevated relative to visible light. In some cases, the bait 120 may incorporate glow-in-the-dark materials that absorb light energy and emit a phosphorescent glow over an extended period. The glow-in-the-dark materials may be charged by exposure to sunlight or artificial light before use, providing enhanced visibility during night fishing or in extremely low-light environments.

The bait 120 may feature contrasting color patterns to mimic natural prey. In some cases, the bait 120 may incorporate two-tone designs having a first color on a dorsal portion and a second color on a ventral portion, simulating the countershading pattern common in many prey species. The bait 120 may alternatively feature spotted patterns distributed across the body surface to mimic the appearance of juvenile fish, crayfish, or other forage species. The contrasting color patterns may include combinations such as chartreuse and white, black and blue, green pumpkin and orange, or other color combinations selected based on water clarity and target species preferences.

In some cases, the weight 102 and bait 120 may be color-matched to present a unified appearance as a single prey item. The color-matching may involve selecting a weight 102 color that corresponds to or complements the primary color of the bait 120, such that the combined assembly appears as a cohesive organism rather than separate components. The color-matched configuration may enhance the natural appearance of the lure assembly and reduce the likelihood of fish detecting the artificial nature of the weight 102.

The bait 120 may be impregnated with fish-attracting scents to stimulate the olfactory senses of target fish. In some cases, the bait 120 may be impregnated with garlic scent, which has been found to attract various freshwater species. The bait 120 may alternatively be impregnated with anise oil, crawfish extract, shad oil, or proprietary fish oil formulations. The scent may be incorporated into the elastomeric material during manufacturing such that the scent disperses gradually throughout the useful life of the bait 120.

In some cases, the bait 120 material may incorporate salt crystals dispersed throughout the elastomeric matrix. The salt crystals provide a flavor-enhancing effect that encourages fish to hold the bait 120 longer after striking, thereby increasing the likelihood of a successful hookset. Other flavor-enhancing additives such as amino acid compounds, fish meal particles, or proprietary flavor formulations may be dispersed throughout the bait 120 material to enhance palatability.

The bait 120 may feature a hollow cavity designed to hold liquid scent attractants. The hollow cavity may be formed within the body of the bait 120 and may include an opening through which liquid scent attractants may be injected. The liquid scent attractants may slowly release through the opening or through pores in the bait 120 material during use, providing a continuous scent trail that attracts fish to the lure assembly.

In some cases, the bait 120 may be constructed from biodegradable materials infused with natural fish pheromones or amino acid compounds. The biodegradable materials may comprise plant-based polymers, starch-based compounds, or other environmentally friendly materials that break down over time when lost in the aquatic environment. The fish pheromones may include compounds that trigger feeding responses or aggregation behaviors in target species.

The weight 102 may incorporate textured surfaces to reduce glare and provide a more natural appearance. In some cases, the weight 102 may feature dimples distributed across the outer surface, similar to the texture of a golf ball, to scatter reflected light and reduce specular highlights. The weight 102 may alternatively feature ridges, grooves, or scale patterns molded or stamped into the outer surface. The textured surface may also provide tactile feedback to fish that contact the weight 102, potentially encouraging continued investigation of the lure assembly.

In some cases, the weight 102 may feature a matte finish to minimize light reflection in clear water conditions where fish may be wary of unnatural flash. The weight 102 may alternatively feature a semi-gloss or high-gloss finish for use in stained or murky water conditions where increased visibility may be beneficial. The finish selection may be based on water clarity, light conditions, and target species behavior.

The bait 120 may incorporate textured surfaces that create micro-turbulence and vibration in the water. In some cases, the bait 120 may feature ribbed surfaces, raised bumps, or irregular contours that disrupt water flow as the bait 120 moves, generating small-scale turbulence detectable by the lateral line sensory system of fish. The textured surfaces may also produce subtle vibrations that mimic the movements of live prey, further enhancing the attractiveness of the lure assembly to predatory fish.

Based upon the foregoing disclosure, it is seen that the present disclosure provides a fishing lure device 100 incorporating visual and sensory attractants that enhance fish attraction through multiple sensory pathways. The visual elements including painted eyes, scale patterns, reflective finishes, and holographic coatings simulate the appearance of natural prey and create attention-grabbing flash in the water. The UV-reactive pigments and glow-in-the-dark materials extend the effectiveness of the lure assembly into low-light conditions where conventional lures may be less visible. The scent impregnation, flavor-enhancing additives, and hollow cavities for liquid attractants stimulate the olfactory and gustatory senses of fish, encouraging longer bite duration and improved hookset rates. The textured surfaces on both the weight 102 and bait 120 reduce unnatural glare while creating micro-turbulence and vibration that appeal to the lateral line sensory system of predatory fish, thereby providing a multi-sensory presentation that surpasses conventional lure designs in attracting and triggering strikes from target species.

The shaft eye 106 at the distal end of the weight shaft 104 may be configured in various forms to accommodate different fishing line attachment methods and angler preferences. In some cases, the shaft eye 106 may be configured as a closed loop formed integrally with the weight shaft 104, providing a permanent and secure attachment point for fishing line 126. In other cases, the shaft eye 106 may be configured as a split ring attachment point, allowing anglers to attach and detach fishing line 126 or terminal tackle without threading the line through a closed loop. The shaft eye 106 may also be configured as a snap swivel connection, enabling rapid changing of the dropshot lure 100 assembly from the fishing line 126 and facilitating quick lure changes during fishing.

The orientation of the shaft eye 106 relative to the weight shaft 104 may vary depending on the desired presentation characteristics and line management requirements. In some cases, the shaft eye 106 may be oriented perpendicular to the shaft axis, positioning the line attachment point at a right angle to the longitudinal axis of the weight shaft 104. In other cases, the shaft eye 106 may be oriented parallel to the shaft axis, aligning the line attachment point along the same direction as the weight shaft 104. The shaft eye 106 may also be oriented at an intermediate angle between perpendicular and parallel orientations, providing a compromise between different presentation characteristics.

The shaft eye 106 may incorporate a line clip mechanism that allows anglers to adjust the depth of the fishing line 126 attachment without retying knots. The line clip mechanism may grip the fishing line 126 at a selected position, enabling quick depth adjustments in response to changing fishing conditions or target species behavior. The line clip mechanism may release and re-engage the fishing line 126 at different positions along the weight shaft 104, providing versatility in bait 120 presentation depth.

In some cases, the shaft eye 106 may feature a swivel mechanism positioned between the line attachment point and the weight shaft 104. The swivel mechanism may rotate freely to prevent line twist that can occur during retrieval of the dropshot lure 100. The swivel mechanism may reduce tangles and maintain line integrity during repeated casting and retrieval cycles.

The weight shaft 104 may incorporate markings or graduations along the length of the weight shaft 104 to indicate line attachment depth. The markings may be spaced at regular intervals, such as one-inch increments, allowing anglers to visually reference the distance between the weight 102 and the line attachment point. The graduations may assist anglers in achieving consistent bait 120 presentation depths across multiple casts.

In some cases, the shaft eye 106 may be replaced with an adjustable line clip that allows the fishing line 126 to be secured at various positions along the weight shaft 104 without tying knots. The adjustable line clip may slide along the weight shaft 104 and lock at a desired position, enabling anglers to modify the distance between the weight 102 and the effective line attachment point. The adjustable line clip may be repositioned during fishing to adapt to different water depths or fish behavior patterns.

The dropshot lure 100 may include one or more retention features configured to prevent the hook 108 from sliding off the weight shaft 104 during use or storage. In some cases, the shaft eye 106 may have a diameter larger than an internal diameter of the hook eye 112 such that the shaft eye 106 retains the hook eye 112 on the weight shaft 104. The shaft eye 106, being formed as an enclosed loop at the distal end of the weight shaft 104, may serve as a stop that prevents the hook eye 112 from passing beyond the shaft eye 106 and disengaging from the weight shaft 104. The hook eye 112 may freely rotate and slide along the weight shaft 104 between the weight 102 and the shaft eye 106, but the enlarged diameter of the shaft eye 106 relative to the hook eye 112 prevents the hook eye 112 from escaping the weight shaft 104.

In some cases, a removable clip, split ring, or small bead may be positioned on the weight shaft 104 between the hook eye 112 and the shaft eye 106 to retain the hook 108 while still permitting free rotation. The removable clip, split ring, or small bead may provide an additional retention point that limits the range of travel of the hook eye 112 along the weight shaft 104. The removable clip, split ring, or small bead may be sized to allow the hook eye 112 to rotate freely around the weight shaft 104 while preventing the hook eye 112 from contacting or passing through the shaft eye 106. In some implementations, the removable clip, split ring, or small bead may be removable to allow the hook 108 to be changed or replaced without disassembling the entire dropshot lure 100.

In some cases, the weight shaft 104 may incorporate a slight bulge or upset portion near the shaft eye 106 that allows the hook eye 112 to pass during assembly but prevents inadvertent disengagement. The bulge or upset portion may be formed by deforming a section of the weight shaft 104 to create a localized increase in diameter. During assembly, the hook eye 112 may be forced over the bulge or upset portion with sufficient pressure to temporarily deform the hook eye 112 or the bulge, allowing the hook eye 112 to pass onto the weight shaft 104. Once assembled, the bulge or upset portion may prevent the hook eye 112 from sliding back over the bulge under normal fishing conditions, thereby retaining the hook 108 on the weight shaft 104.

In some cases, the retention mechanism may be designed to release under a predetermined force to allow the hook 108 to separate from the weight 102 when snagged. A breakaway retention mechanism may be configured such that when the hook 108 becomes lodged on an underwater obstacle, the angler may apply tension to the fishing line 126 that exceeds the predetermined release force of the retention mechanism. Upon exceeding the predetermined release force, the hook 108 may separate from the weight shaft 104, allowing the angler to retrieve the weight 102 while sacrificing the hook 108. The breakaway retention mechanism may reduce the loss of the entire dropshot lure 100 when the hook 108 becomes snagged, as the weight 102 and weight shaft 104 may be recovered for reuse with a replacement hook.

In some cases, the dropshot lure 100 may be configured for saltwater fishing environments with enhanced corrosion resistance. For saltwater applications, all metal components of the dropshot lure 100 may be constructed from marine-grade stainless steel. In other cases, all metal components may be constructed from titanium. In still other cases, all metal components may be constructed from corrosion-resistant alloys suitable for prolonged exposure to saltwater environments. The selection of marine-grade materials may extend to the weight 102, the weight shaft 104, the shaft eye 106, the hook 108, and the hook eye 112 to provide comprehensive protection against saltwater corrosion throughout the dropshot lure 100 assembly.

In some cases, the weight 102 may be coated with protective finishes to resist saltwater degradation. The weight 102 may be coated with epoxy to provide a barrier against saltwater contact with the underlying weight material. In other cases, the weight 102 may be coated with powder coating to resist saltwater degradation. In still other cases, the weight 102 may be coated with other protective finishes such as ceramic coatings, fluoropolymer coatings, or multi-layer protective systems. The protective coating may extend over the entire exterior surface of the weight 102 or may be applied to selected portions of the weight 102 that are most susceptible to saltwater exposure.

In some cases, the dropshot lure 100 may be scaled up in size for offshore bottom fishing applications. The weight 102 may range from approximately 1 ounce to 4 ounces or more for targeting bottom-dwelling species in deep water offshore environments. In some cases, the weight 102 may be approximately 1 ounce for moderate depth offshore applications. In other cases, the weight 102 may be approximately 2 ounces for deeper water applications. In still other cases, the weight 102 may be approximately 3 ounces or approximately 4 ounces or more for deep water offshore bottom fishing where heavier weights are needed to maintain bottom contact against strong currents and to reach greater depths efficiently. The scaled-up weight 102 sizes may be combined with correspondingly larger hooks 108 and baits 120 to target larger offshore species such as grouper, snapper, and other demersal fish.

In some cases, a dropshot lure 100 may incorporate multiple hooks 108 rotatably mounted on a weight shaft 104 to increase hookup rates or present multiple baits 120 simultaneously. Two or more hooks 108 may be positioned on the weight shaft 104, with each hook 108 having a hook eye 112 that encircles and rotates freely around the weight shaft 104. The multiple hooks 108 may be oriented in different directions around the weight shaft 104 to provide coverage from multiple angles. The hooks 108 may be of different sizes or styles to target different fish species simultaneously, or the hooks 108 may be of uniform size and style for consistent presentation.

Spacing elements may be positioned between the hooks 108 on the weight shaft 104 to prevent tangling during casting, retrieval, and storage. The spacing elements may include beads, bushings, collars, or tubular spacers that slide onto the weight shaft 104 between adjacent hook eyes 112. The spacing elements may be constructed from plastic, rubber, metal, or ceramic materials. The spacing elements maintain a predetermined distance between adjacent hooks 108, allowing each hook 108 and attached bait 120 to move independently without interference from neighboring hooks. The spacing elements may be sized to permit free rotation of each hook eye 112 while preventing the hook eyes 112 from contacting one another.

In some cases, a weight 102 may incorporate internal chambers containing loose beads, BBs, or other elements that produce sound when the device is moved. The sound-producing elements may rattle, click, or clatter within the internal chambers as the dropshot lure 100 is jigged, dragged, or otherwise manipulated by an angler. The sound produced by the loose elements may attract fish by mimicking the sounds of prey items such as crayfish clicking their claws or baitfish schooling. The loose elements within the internal chambers may be constructed from glass, metal, plastic, or ceramic materials, with different materials producing different sound frequencies and intensities.

In some cases, a weight 102 may be constructed with a hollow cavity containing glass or metal rattles to create clicking or rattling sounds that attract fish. The hollow cavity may be formed within the weight 102 body during casting or molding, or the hollow cavity may be created by assembling two or more weight 102 body portions around the rattles. The glass or metal rattles may be spherical, cylindrical, or irregularly shaped. The size and number of rattles within the hollow cavity may be varied to produce different sound characteristics. The rattles may be tuned to specific frequencies known to attract particular fish species. The hollow cavity may be sealed to prevent water intrusion while permitting the rattles to move freely within the cavity.

The fishing lure device 100 may be configured with modular and interchangeable components allowing anglers to customize the setup for different fishing conditions and target species. The modular design may permit rapid field adjustments without requiring complete disassembly or re-rigging of the entire fishing line setup.

In some cases, the weight 102 may be detachable from the shaft assembly to allow weight changes without re-rigging. The detachable connection between the weight 102 and the shaft may be accomplished through various mechanisms including threaded connections, snap-fit arrangements, bayonet-style mounts, or friction-fit couplings. The detachable weight 102 configuration may permit an angler to quickly swap between different weight 102 sizes or shapes to accommodate changing water depths, current conditions, or bottom substrate types without removing the hook 108 or bait 120 from the assembly. For example, an angler may carry a selection of weights 102 ranging from lighter weights for shallow water applications to heavier weights for deep water or strong current situations, and may interchange the weights 102 as conditions change throughout a fishing session.

The hook 108 may be provided with a quick-change mechanism allowing different hook 108 styles to be swapped without disassembly of the remaining components. The quick-change mechanism may include a split ring, snap connector, or releasable clip that permits the hook 108 to be removed from and reattached to the shaft while maintaining the rotatable connection characteristic of the device. The quick-change hook 108 configuration may allow anglers to switch between different hook 108 styles such as offset hooks, wide-gap hooks, circle hooks, or finesse hooks depending on the bait 120 type being used or the target species being pursued. The quick-change mechanism may also facilitate replacement of damaged or dulled hooks 108 without requiring re-rigging of the entire assembly.

The shaft may be available in different lengths that can be interchanged with a common weight 102 and hook 108 system. Interchangeable shafts of varying lengths may provide different separation distances between the weight 102 and the hook 108, which may affect bait 120 presentation characteristics and the height at which the bait 120 suspends above the bottom substrate 124. Shorter shafts may position the bait 120 closer to the bottom for targeting species that feed directly on or near the substrate, while longer shafts may suspend the bait 120 at greater heights above the bottom for targeting species that feed in the lower portion of the water column. The interchangeable shaft system may employ standardized connection interfaces at both the weight 102 end and the shaft eye 106 end to ensure compatibility across different shaft lengths.

In some cases, the shaft may extend from the top of the weight 102 to provide a vertical orientation when the weight 102 rests on the bottom substrate 124. In other cases, the shaft may extend from the side of the weight 102 to provide a horizontal or angled orientation relative to the bottom substrate 124. The shaft may also extend at an angle from the weight 102 to provide different presentation characteristics. The position from which the shaft extends from the weight 102 may affect how the bait 120 orients in the water and how the device responds to retrieval movements imparted by the angler. A shaft extending from the top of the weight 102 may position the bait 120 directly above the weight 102, while a shaft extending from the side or at an angle may offset the bait 120 laterally from the weight 102 position.

The line attachment point may be offset from the central axis of the weight 102 to create a specific action or orientation when retrieved. An offset line attachment point may cause the device to track to one side during retrieval or may impart a wobbling or rocking motion as the device moves through the water. The offset configuration may also affect how the device settles on the bottom substrate 124 and how the bait 120 orients relative to the weight 102 when at rest.

In some cases, multiple line attachment points may be provided to allow anglers to select different rigging configurations. The multiple attachment points may be positioned at different locations along the shaft or at different orientations relative to the weight 102. An angler may select among the multiple attachment points to achieve different bait 120 presentations, retrieval actions, or hook-setting characteristics depending on the fishing technique being employed and the behavior of the target species.

Based upon the foregoing disclosure, it is seen that the present disclosure provides a fishing lure device 100 with modular and interchangeable component configurations that offer enhanced versatility compared to fixed-configuration fishing rigs. The modular design permits anglers to adapt the device to varying fishing conditions without carrying multiple complete rigs, reduces time spent re-rigging on the water, and allows customization of weight 102, hook 108 style, shaft length, and line attachment position to optimize bait 120 presentation for different target species and fishing environments.

The weight 102 and shaft assembly may be manufactured as a single integrated unit through various processes. In some cases, the weight 102 and shaft assembly may be formed through casting processes, wherein molten metal is poured into a mold cavity shaped to define both the weight 102 body and the shaft extending therefrom. The casting process may employ sand casting, investment casting, or die casting depending on the desired production volume and dimensional tolerances. In other cases, the weight 102 and shaft assembly may be manufactured through forging processes, wherein a metal workpiece is shaped under compressive forces to form the integrated weight 102 and shaft configuration. Forging may produce a weight 102 and shaft assembly having enhanced grain structure and mechanical properties compared to cast components. In still other cases, the weight 102 and shaft assembly may be manufactured through machining processes, wherein material is removed from a solid metal blank using cutting tools to define the weight 102 body, the shaft, and the shaft eye 106. Machining processes may include turning, milling, drilling, or combinations thereof.

The weight 102 may be molded around the shaft using insert molding techniques. In insert molding, the shaft may be positioned within a mold cavity as a pre-formed insert, and molten material may be injected or poured around the shaft to form the weight 102 body. The insert molding process may create a mechanical interlock between the weight 102 body and the shaft, or the weight 102 material may bond directly to the shaft surface. Insert molding may be performed using metal injection molding, wherein a mixture of metal powder and binder is injected around the shaft insert and subsequently sintered to form a dense metal weight 102 body. In some cases, insert molding may employ polymer-metal composite materials or weighted polymer materials to form the weight 102 body around a metal shaft insert.

The shaft may be attached to the weight 102 through various joining methods. In some cases, the shaft may be attached to the weight 102 through welding, wherein the shaft and weight 102 are fused together by applying heat to melt the base materials at the joint interface. Welding methods may include resistance welding, laser welding, or electron beam welding. In other cases, the shaft may be attached to the weight 102 through brazing, wherein a filler metal having a melting point lower than the base materials is melted and drawn into the joint by capillary action. Brazing may produce a joint having high strength while minimizing thermal distortion of the weight 102 and shaft components. In still other cases, the shaft may be attached to the weight 102 through soldering, wherein a lower-melting-point filler metal is used to join the components. Soldering may be suitable for applications where lower joint strength is acceptable or where thermal sensitivity of the materials precludes higher-temperature joining processes. In further cases, the shaft may be attached to the weight 102 through mechanical fastening, wherein the shaft is secured to the weight 102 using threads, press-fit connections, crimping, staking, or other mechanical interlocking features.

The hook eye 112 may be formed through various manufacturing methods. In some cases, the hook eye 112 may be formed through bending wire stock, wherein a length of wire is bent into a closed or partially closed loop configuration using bending dies, mandrels, or automated wire forming equipment. Wire bending may produce hook eyes 112 having consistent dimensions and smooth interior surfaces that facilitate free rotation on the weight shaft 104. In other cases, the hook eye 112 may be formed through forging, wherein a metal blank is shaped under compressive forces to define the hook eye 112 geometry. Forging may produce a hook eye 112 having enhanced strength and fatigue resistance compared to bent wire configurations. In still other cases, the hook eye 112 may be formed through precision casting, wherein molten metal is poured into a mold cavity shaped to define the hook eye 112 and hook shank 110 as an integrated component. Precision casting methods may include investment casting or die casting.

The components of the fishing lure device 100 may be manufactured using additive manufacturing techniques. In some cases, the weight 102, the shaft, or the weight 102 and shaft assembly may be manufactured using metal three-dimensional printing processes such as selective laser melting, direct metal laser sintering, or electron beam melting. Additive manufacturing may enable production of custom weight 102 configurations having complex geometries that would be difficult or impossible to achieve through conventional casting, forging, or machining processes. In some cases, additive manufacturing may be used to produce weight 102 bodies having internal cavities, lattice structures, or density gradients tailored to specific fishing applications. Additive manufacturing may also enable rapid prototyping of new weight 102 and shaft configurations for testing and evaluation prior to committing to conventional production tooling.

Based upon the foregoing disclosure, it is seen that the present disclosure provides a fishing lure device 100 that may be manufactured through a variety of processes suited to different production volumes, material requirements, and performance specifications. The manufacturing flexibility afforded by casting, forging, machining, insert molding, welding, brazing, soldering, mechanical fastening, wire bending, precision casting, and additive manufacturing techniques may enable production of fishing lure devices 100 tailored to specific fishing applications, target species, and environmental conditions while maintaining the freely rotating hook 108 assembly that allows natural bait 120 presentation.

A method of fishing using the dropshot lure 100 device is now described. The method includes providing a fishing lure device 100 comprising a weight 102, a weight shaft 104 extending from the weight 102 and terminating in a shaft eye 106, a hook 108 having a hook eye 112 that encircles the weight shaft 104 between the weight 102 and the shaft eye 106, wherein the hook eye 112 is freely rotatable around the weight shaft 104, and a bait 120 attached to the hook 108. As described previously, the hook eye 112 may be sized to permit free rotation and pivoting movement around the weight shaft 104, allowing the bait 120 to respond naturally to water movement.

The method further includes attaching a fishing line 126 to the shaft eye 106. The fishing line 126 may be tied directly to the shaft eye 106 using a knot, or the fishing line 126 may be connected to the shaft eye 106 using a snap swivel or other connector. The attachment of the fishing line 126 to the shaft eye 106 rather than directly to the hook 108 allows the hook 108 and bait 120 to move independently of the fishing line 126 tension in certain conditions.

The method further includes casting the fishing lure device 100 into a body of water. The casting may be performed using a spinning rod, baitcasting rod, or other fishing rod suitable for the weight of the device and the target species. The device may be cast to a desired location where bottom-dwelling fish are expected to be present.

The method further includes allowing the weight 102 to rest on a bottom substrate 124 of the body of water while the bait 120 moves freely relative to the weight 102 in response to water currents. When the weight 102 contacts and rests on the bottom substrate 124, the weight 102 anchors the device in position while the freely rotatable connection between the hook eye 112 and the weight shaft 104 permits the bait 120 to rotate and pivot in response to water currents, wave action, or subtle movements imparted by the angler through the fishing line 126.

In some cases, the bait 120 is an elastomeric lure that is buoyant such that the bait 120 maintains an upward orientation relative to the weight 102 when the weight 102 rests on the bottom substrate 124. The buoyancy of the elastomeric lure causes the bait 120 to float upward from the weight shaft 104 while the weight 102 remains stationary on the bottom substrate 124. This upward orientation positions the bait 120 above the bottom substrate 124 where the bait 120 is visible to fish in the water column.

In some cases, the elastomeric lure is shaped to resemble a crayfish positioned in a defensive posture with claws oriented upwardly. The buoyancy of the elastomeric lure combined with the freely rotatable hook eye 112 causes the crayfish-shaped bait 120 to assume a natural defensive posture with the claws angled upward, mimicking the appearance of a live crayfish resting on the bottom of a lake or river bed. This natural presentation may increase the attractiveness of the bait 120 to predatory fish such as bass that feed on crayfish.

The freely rotatable connection between the hook eye 112 and the weight shaft 104 provides an advantage during a fish strike. When a fish strikes the bait 120, the fish does not immediately feel the resistance of the weight 102 because the hook 108 is not rigidly connected to the weight 102. This allows the fish to commit to the bite before sensing any unnatural resistance. When the angler sets the hook 108 by pulling on the fishing line 126, the force transfers through the shaft eye 106 to the weight shaft 104, and the hook eye 112 is pulled toward the shaft eye 106, transferring the force through the hook 108 to set the hook 108 in the fish.

Based upon the foregoing disclosure, it is seen that the present disclosure provides a fishing lure device 100 and method of fishing that allows for natural bait 120 presentation while maintaining the benefits of a dropshot weight configuration. The freely rotatable hook 108 assembly permits the bait 120 to move independently of the weight 102 in response to water currents, creating lifelike movement that may attract fish. The device reduces the likelihood of fish detecting the weight 102 when striking the bait 120, potentially leading to increased hookup rates. The buoyant elastomeric bait 120 maintains an upward orientation resembling a defensive crayfish posture, providing a natural appearance to predatory fish. The device also simplifies rigging compared to traditional dropshot setups by integrating the hook 108 directly on the weight shaft 104, reducing line tangles and snagging. The separation of the hook 108 from the weight 102 through the rotatable connection may reduce wear on the hook 108 and allow the hook 108 to orient itself during hook setting, potentially improving hook penetration and fish retention.

The freely rotatable connection between the hook eye 112 and the weight shaft 104 provides a mechanism whereby a fish striking the bait 120 does not immediately feel resistance from the weight 102. Because the hook 108 is not rigidly connected to the weight 102, the fish may commit to the strike without detecting the unnatural heaviness that would otherwise cause the fish to release the bait 120 prematurely. This delayed resistance detection may result in more committed strikes and higher hookup rates compared to configurations where the hook 108 and weight 102 are rigidly connected.

During the hook-setting motion when an angler pulls on the fishing line 126, force transfers through the device in a specific sequence. The force transfers from the fishing line 126 through the shaft eye 106 to the weight shaft 104. As tension increases, the hook eye 112 bears against the shaft eye 106, and force then transfers from the weight shaft 104 to the hook eye 112. From the hook eye 112, force transfers through the hook shank 110 and curved portion 114 to the hook point, driving the hook 108 into the fish. Throughout this force transfer sequence, the hook 108 may retain some freedom to rotate and pivot, allowing the hook 108 to orient in response to the angle and direction of the fish's movement.

When the angler sets the hook 108 by pulling on the line, the hook 108 automatically orients to set in the top lip of the fish due to the force being applied through the weight 102. Setting the hook 108 in the top lip provides advantages for fish retention, as the top lip is a location where fish have difficulty using teeth to cut the line and where downward pulling by the fish tends to drive the hook 108 deeper rather than dislodging the hook 108.

The non-rigid connection between the hook 108 and the weight 102 also provides a snag release function. If the hook 108 gets stuck on underwater structure or debris, the angler may pull the weight 102 because the weight 102 is not rigidly connected to the hook 108. This separation may allow the angler to manipulate the weight 102 independently to free the hook 108, reducing the likelihood of losing the entire device. Similarly, if the weight 102 becomes snagged, the hook 108 may remain free, allowing the angler to recover at least a portion of the device. This snag release function may reduce tackle loss and increase fishing time compared to configurations where the hook 108 and weight 102 are rigidly connected and must be recovered or lost together.

Based upon the foregoing disclosure, it is seen that the present disclosure provides a fishing lure device 100 that achieves natural bait 120 movement independent of the weight 102 while maintaining bottom contact. The freely rotating hook 108 assembly allows the bait 120 to exhibit lifelike movement in response to water currents, angler manipulation, or fish activity without being constrained by the stationary weight 102 resting on the bottom substrate 124. The hook eye 112 encircling the weight shaft 104 permits full 360-degree rotation in the plane perpendicular to the shaft axis, as well as angular pivoting along the shaft axis, enabling the bait 120 to move in multiple directions and orientations that closely mimic the behavior of live prey.

The fishing lure device 100 may provide enhanced hookup rates compared to conventional dropshot rigs where the hook 108 is rigidly connected to the weight 102. When a fish strikes the bait 120, the fish does not immediately feel the resistance of the weight 102 because the rotatable connection between the hook eye 112 and the weight shaft 104 allows the hook 108 and bait 120 to move freely. In prior art configurations where the hook is fixed relative to the weight, fish often detect the unnatural heaviness upon biting and release the bait before the angler can set the hook. The freely rotating hook 108 design of the present disclosure may result in fish committing more fully to strikes, thereby increasing catch rates.

The fishing lure device 100 may also provide advantageous hook 108 placement during the hook-setting motion. When the angler pulls on the fishing line 126 to set the hook 108, the force transfers through the shaft eye 106 to the weight shaft 104, and the hook eye 112 is pulled toward the shaft eye 106. Because the fishing line 126 is attached to the weight 102 rather than directly to the hook 108, the hook 108 tends to orient such that the hook tip 116 engages the top lip of the fish. Top lip hook 108 placement may reduce the likelihood of the fish throwing the hook 108 or cutting the line with teeth, and may result in the fish hooking itself more deeply when pulling downward against the angler.

The fishing lure device 100 may reduce tackle loss in rocky or structured environments. In conventional rigs where the hook and weight are rigidly connected, a snagged hook often results in loss of the entire rig because the angler pulls against both the hook and the weight simultaneously. With the freely rotating hook 108 design, if the hook 108 becomes snagged, the angler may be able to pull the weight 102 free because the weight 102 is not rigidly attached to the hook 108. Conversely, if the weight 102 becomes snagged, the hook 108 may remain free, allowing the angler to manipulate the rig and potentially dislodge the snag without losing the entire assembly.

The fishing lure device 100 may be used across a wide range of fishing conditions, water depths, bait types, and target species. The weight 102 may be provided in various sizes to accommodate shallow water finesse applications or deep water and strong current situations. The bait 120 may be configured in various shapes including worm, minnow, crayfish, goby, or other forage species profiles, and may be constructed from elastomeric materials with varying degrees of buoyancy to achieve different orientations in the water. The device may be effective for targeting bottom-dwelling species as well as fish suspended in the water column, and may be used in still water, moving current, freshwater, and saltwater environments.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A fishing lure device, comprising:
a weight;
a weight shaft extending from the weight and terminating in a shaft eye configured for attachment of a fishing line; and
a hook having a hook eye that encircles the weight shaft between the weight and the shaft eye, wherein the hook eye is freely rotatable around the weight shaft.

2. The fishing lure device of claim 1, wherein the weight is selected from the group consisting of a spherical weight, a cylindrical weight, a teardrop-shaped weight, a disc-shaped weight, and an elongated rod-shaped weight.

3. The fishing lure device of claim 1, further comprising a bait attached to the hook.

4. The fishing lure device of claim 3, wherein the bait is an elastomeric lure.

5. The fishing lure device of claim 4, wherein the elastomeric lure is shaped to resemble a crayfish.

6. The fishing lure device of claim 4, wherein the elastomeric lure is buoyant such that the bait maintains an upward orientation when the weight rests on a bottom substrate.

7. The fishing lure device of claim 1, wherein the hook eye has an internal diameter larger than an external diameter of the weight shaft such that the hook eye is configured to both rotate around the weight shaft and pivot angularly along an axis of the weight shaft.

8. The fishing lure device of claim 1, wherein the shaft eye has a diameter larger than an internal diameter of the hook eye such that the shaft eye retains the hook eye on the weight shaft.

9. The fishing lure device of claim 1, wherein the hook comprises a barb formed near a hook tip.

10. The fishing lure device of claim 1, wherein the weight shaft is straight along an entire length thereof between the weight and the shaft eye.

11. The fishing lure device of claim 1, wherein the weight shaft is constructed from a corrosion-resistant material.

12. A method of fishing, comprising:
providing a fishing lure device comprising a weight, a weight shaft extending from the weight and terminating in a shaft eye, and a hook having a hook eye that encircles the weight shaft between the weight and the shaft eye, wherein the hook eye is freely rotatable around the weight shaft;
attaching a fishing line to the shaft eye;
casting the fishing lure device into a body of water; and
allowing the weight to rest on a bottom substrate of the body of water.

13. The method of claim 12, further comprising attaching a bait to the hook.

14. The method of claim 13, wherein the bait is a buoyant elastomeric lure such that the bait maintains an upward orientation relative to the weight when the weight rests on the bottom substrate.

15. The method of claim 14, wherein the elastomeric lure is shaped to resemble a crayfish positioned in a defensive posture with claws oriented upwardly.

16. The method of claim 12, wherein the hook eye has an internal diameter larger than an external diameter of the weight shaft such that the hook is configured to both rotate around the weight shaft and pivot angularly along an axis of the weight shaft.

17. The method of claim 13, further comprising setting the hook in a fish that strikes the bait, wherein the fish does not feel resistance from the weight prior to the hook being set due to the freely rotatable connection between the hook eye and the weight shaft.

18. A fishing lure device, comprising:
a weight configured to rest on a bottom substrate of a body of water;
a weight shaft having a first end connected to the weight and a second end opposite the first end, the second end having a shaft eye configured for attachment of a fishing line; and
a hook comprising a hook eye and a hook tip, the hook eye encircling the weight shaft between the weight and the shaft eye such that the hook is freely rotatable around the weight shaft and freely pivotable along an axis of the weight shaft.

19. The fishing lure device of claim 18, further comprising a buoyant elastomeric bait attached to the hook, wherein the buoyant elastomeric bait is configured to orient the hook at an upward angle relative to the weight shaft when the weight rests on the bottom substrate.

20. The fishing lure device of claim 18, wherein the shaft eye has a diameter larger than an internal diameter of the hook eye such that the shaft eye retains the hook eye on the weight shaft.
